(19) United States
(12) Patent Application Publication
(10) Pub. No.: US 2025/0060602 A1
(43) Pub. Date: Feb. 20, 2025

(54) WEARABLE PROJECTION DEVICE

(71) Applicant: Coretronic Corporation, Hsin-Chu (TW)

(72) Inventors: Yao-Hung Chen, Hsin-Chu (TW); Wei-Min Chien, Hsin-Chu (TW)

(73) Assignee: Coretronic Corporation, Hsin-Chu (TW)

(21) Appl. No.: 18/779,071

(22) Filed: Jul. 21, 2024

(30) Foreign Application Priority Data
Aug. 14, 2023 (CN) 202311016300.4

(51) Int. Cl. G02B 27/01; G03B 21/14; G03B 21/16

(52) U.S. Cl. CPC G02B 27/0176; G02B 27/0172; G03B 21/145; G03B 21/16; G02B 2027/0178

(57) ABSTRACT

A wearable projection device includes a body, an optical engine module, a heat-dissipation component, and a control module. The body has an air inlet, and a containing space connected to the air inlet. The optical engine module is disposed in the containing space. The heat-dissipation component disposed in the containing space is configured to dissipate heat from the optical engine module. The heat-dissipation component includes a vapor chamber and an airflow generator. The vapor chamber is connected to the optical engine module. The airflow generator is positioned on the vapor chamber, and the airflow generator includes a piezoelectric thin film. The control module is disposed on the body, electrically connected to the optical engine module and the airflow generator, and configured to drive the piezoelectric thin film to vibrate, so that an external cooling airflow enters the containing space through the air inlet to cool the vapor chamber.

### CROSS-REFERENCE TO RELATED APPLICATION

This application claims the priority benefit of China application serial no. 202311016300.4, filed on Aug. 14, 2023. The entirety of the above-mentioned patent application is hereby incorporated by reference herein and made a part of this specification.

### BACKGROUND

### Technical Field

The disclosure relates to a projection device, and particularly relates to a wearable projection device.

### Description of Related Art

As the technology industry becomes increasingly developed, the types, functions, and methods of use of projection devices are becoming diverse, and wearable projection devices that can be worn directly on the body of a user have also emerged accordingly. In terms of heat dissipation of current wearable projection devices, if natural convection heat dissipation is adopted, then a larger surface area is required for heat dissipation, thereby the purpose of making the wearable projection device lightweight cannot be achieved. On the contrary, if forced convection heat dissipation is adopted, then a blower and an axial fan are required. However, under the same volume and noise specification, the amount of heat dissipated by the blower and the axial fan is low and the efficiency is poor. In addition, if the wearable projection device is used outdoors, adopting the forced convection heat dissipation method is likely to have dust covering the air outlet/inlet, resulting in a decrease in the heat dissipation effect.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a wearable projection device, which has a good heat dissipation effect and display quality.

Other purposes and advantages of the disclosure may be further understood from the technical features disclosed in the disclosure.

In order to achieve one, part of, or all of the above purposes or other purposes, an embodiment of the disclosure provides a wearable projection device including a body, an optical engine module, a heat-dissipation component, and a control module. The body has an air inlet, and the body has a containing space connected to the air inlet. The optical engine module is disposed in the containing space of the body. The heat-dissipation component is disposed in the containing space of the body configured to dissipate heat from the optical engine module. The heat-dissipation component includes a vapor chamber and an airflow generator. The vapor chamber is connected to the optical engine module. The airflow generator is positioned on the vapor chamber, and the airflow generator includes a piezoelectric thin film. The control module is disposed on the body and electrically connected to the optical engine module and the airflow generator. The control module is configured to drive the piezoelectric thin film to vibrate, so that the cooling airflow from outside enters the containing space of the body through the air inlet, so as to cool the vapor chamber.

In an embodiment of the disclosure, the body further has an air outlet connected to the containing space. The body includes a display part and a support part connected to each other. The containing space is positioned in the display part. The display part of the body includes a first side wall and a second side wall opposite to each other and a connection wall connecting the first side wall and the second side wall. The air inlet is disposed on the first side wall, and the air outlet is disposed on the connection wall. The first side wall of the display part faces the user of the wearable projection device.

In an embodiment of the disclosure, the wearable projection device further includes an airflow adjustment structure, which is disposed on the body and positioned at the air outlet. When the control module drives the airflow generator, the airflow adjustment structure is configured to guide the cooling airflow to be discharged from the containing space through the air outlet.

In an embodiment of the disclosure, the wearable projection device further includes a dust filter, which is disposed on the body and covers the air outlet. The dust filter is positioned between the airflow generator and the airflow adjustment structure. When the airflow generator is not in operation, the airflow adjustment structure is closed to cover the dust filter.

In an embodiment of the disclosure, the wearable projection device further includes a buffer member disposed between the vapor chamber and the airflow generator. The airflow generator connects the vapor chamber through the buffer member.

In an embodiment of the disclosure, the buffer member includes a thermal interface material.

In an embodiment of the disclosure, the wearable projection device further includes a thermal conductive material disposed between the vapor chamber and the optical engine module. The control module is disposed in the containing space. The thermal conductive material is disposed between the vapor chamber and the control module.

In an embodiment of the disclosure, the orthographic projection of the control module on the vapor chamber does not overlap the orthographic projection of the optical engine module on the vapor chamber.

In an embodiment of the disclosure, the airflow generator further includes a heat sink, and the piezoelectric thin film is connected to the heat sink.

In an embodiment of the disclosure, the wearable projection device further includes an airflow adjustment structure, which is disposed on the body and positioned at the air inlet. When the control module drives the airflow generator, the airflow adjustment structure is configured to guide the cooling airflow to enter the containing space through the air inlet.

In an embodiment of the disclosure, the wearable projection device further includes a dust filter, which is disposed on the body and covers the air inlet. The dust filter is positioned between the airflow generator and the airflow adjustment structure. When the airflow generator is not in operation, the airflow adjustment structure is closed to cover the dust filter.

In an embodiment of the disclosure, the airflow adjustment structure includes a louver structure. The louver structure includes a plurality of louver blades. The plurality of louver blades are arranged parallel to each other without interference. The width of each of the plurality of louver blades is less than or equal to the wall thickness of the body.

In an embodiment of the disclosure, when the airflow generator is in operation, each of the plurality of louver blades opens in a single direction, so that the cooling airflow may enter the containing space through a space between any two adjacent louver blades of the plurality of louver blades. When the airflow generator is not in operation, the plurality of louver blades of the louver structure are closed to cover the air inlet.

In an embodiment of the disclosure, the optical engine module includes a light source device, an imaging module, and a lens module. The light source device is suitable for emitting an illumination light beam. The imaging module is disposed on the transmission path of the illumination light beam and is configured to convert the illumination light beam to generate an image light beam. The lens module is disposed on the transmission path of the image light beam to project the image light beam out of the body.

In an embodiment of the disclosure, the cooling airflow enters the containing space from the air inlet and flows along an airflow direction generated by the airflow generator. The thermal conductivity coefficient of the vapor chamber gradually increases along the airflow direction.

Based on the above, the embodiments of the disclosure have at least one of the following advantages or effects. In the design of the wearable projection device according to the disclosure, the heat-dissipation component includes the vapor chamber and the airflow generator including the piezoelectric thin film, in which the vapor chamber is connected to the optical engine module, and the airflow generator is positioned on the vapor chamber. When the control module drives the piezoelectric thin film to vibrate, the external cooling airflow may enter the containing space of the body from the air inlet, so as to cool the vapor chamber. That is to say, so as to impingement cool the vapor chamber after passing through the piezoelectric thin film. In this way, the fluid usage efficiency is improved, and the noise can be expected to be reduced under the same power consumption. In short, the wearable projection device according to the disclosure can have a good heat dissipation effect and display quality.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic three-dimensional view of a wearable projection device according to an embodiment of the disclosure.

FIG. 2 is a schematic partial front view of the wearable projection device in FIG. 1.

FIG. 3 is a schematic view of an optical engine module of the wearable projection device in FIG. 1.

FIG. 4 is a schematic cross-sectional view of the optical engine module in FIG. 3.

FIG. 5 is a schematic cross-sectional view of an airflow generator of the wearable projection device in FIG. 1.

FIG. 6A is a schematic rear perspective view of the wearable projection device in FIG. 1.

FIG. 6B is a schematic rear perspective view of an airflow adjustment structure in FIG. 6A when it is closed.

FIG. 7 is a schematic partial top perspective view of the wearable projection device in FIG. 1.

FIG. 8A is a schematic partial front view of the wearable projection device in FIG. 6A.

FIG. 8B is a schematic partial front view of the airflow adjustment structure in FIG. 8A when it is closed.

FIG. 9A is a schematic cross-sectional partial side view of the wearable projection device in FIG. 1.

FIG. 9B is a schematic cross-sectional partial side view of the airflow adjustment structure in FIG. 9A when it is closed.

FIG. 10A is a schematic partial side view of the wearable projection device in FIG. 1 when the airflow adjustment structure positioned at the air outlet is opened.

FIG. 10B is a schematic partial side view of the airflow adjustment structure in FIG. 10A when it is closed.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

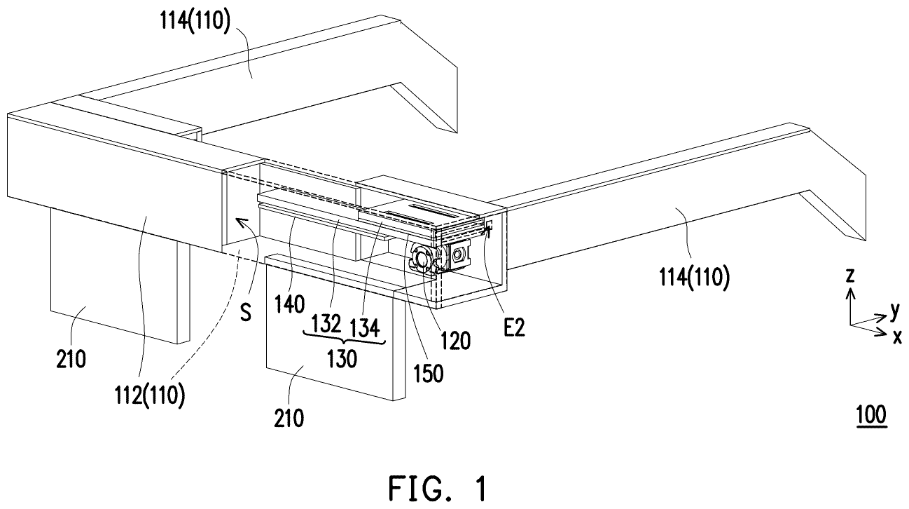

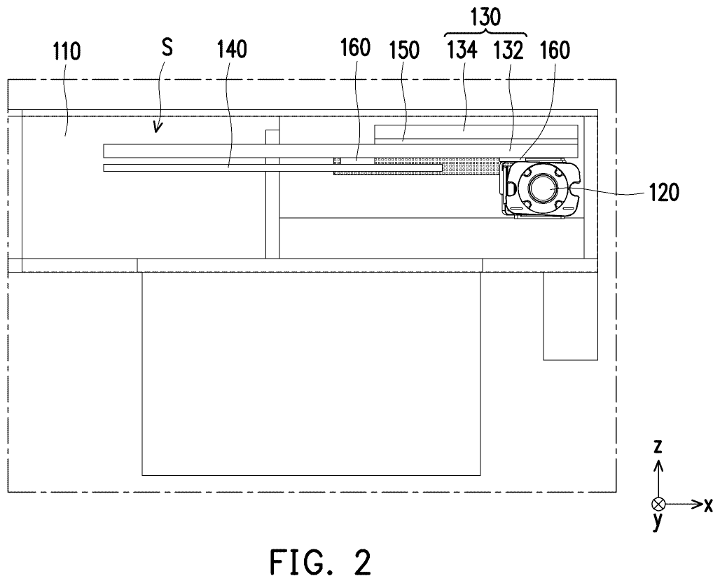

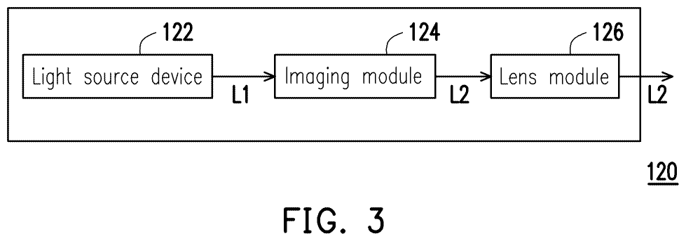

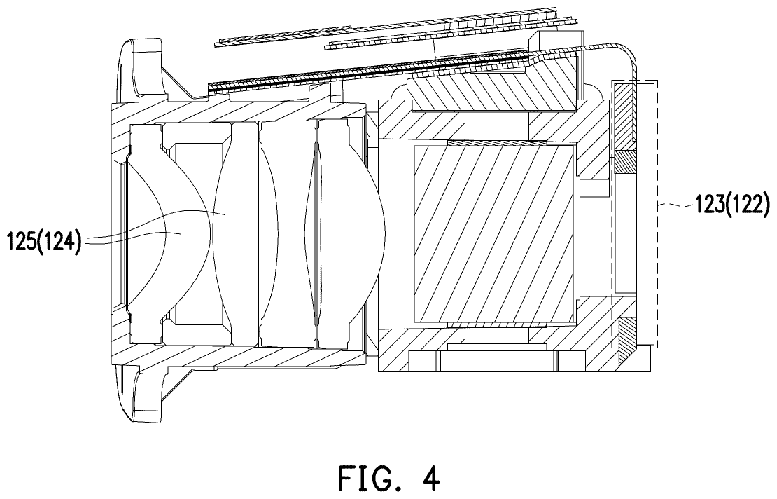

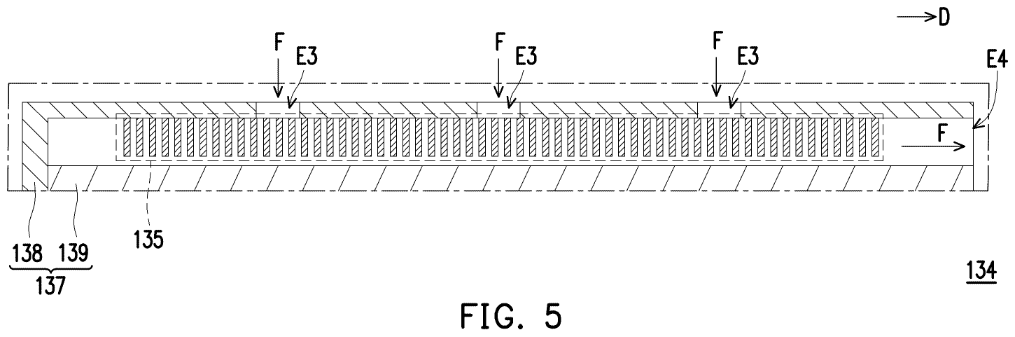

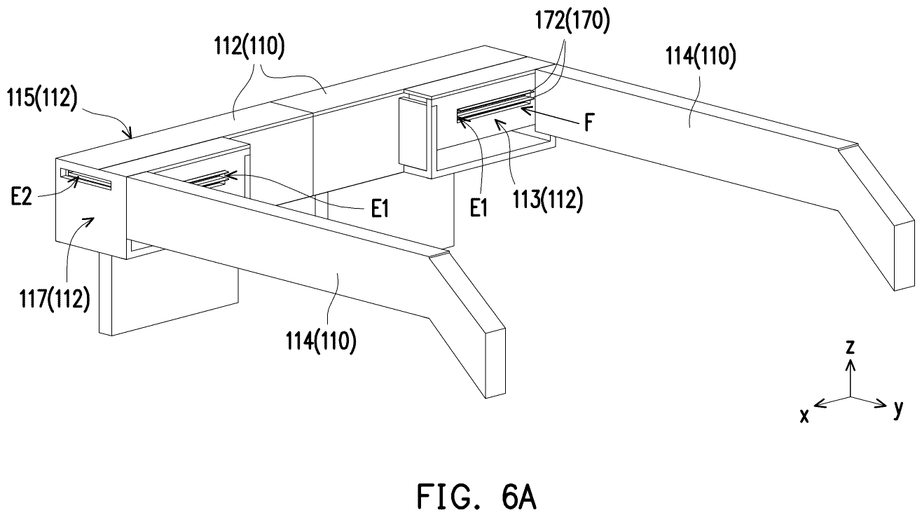

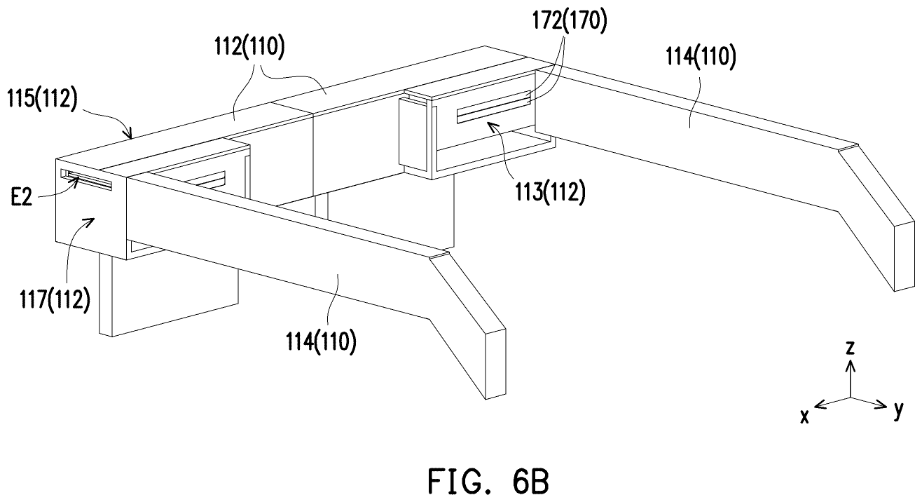

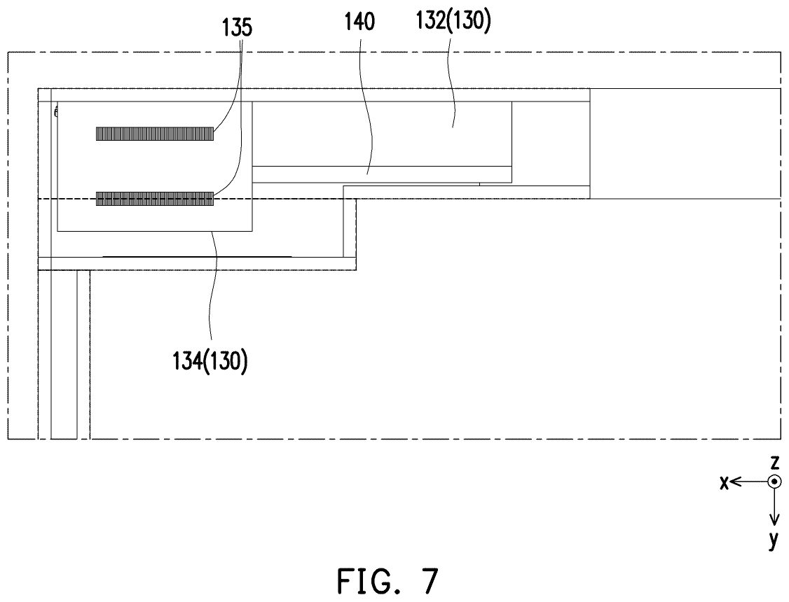

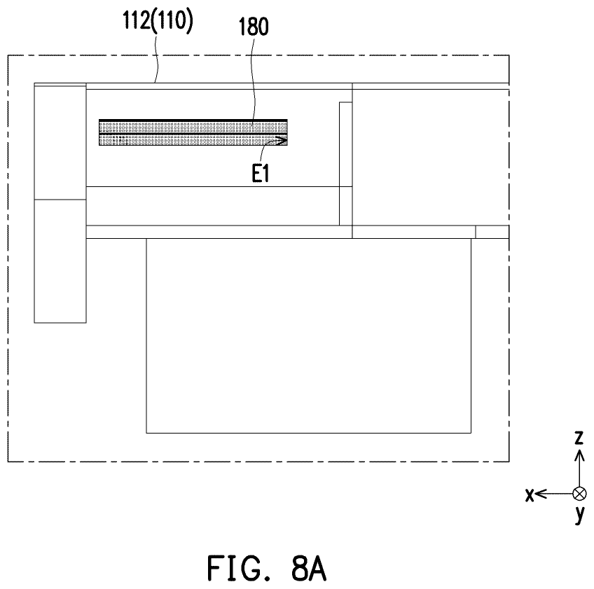

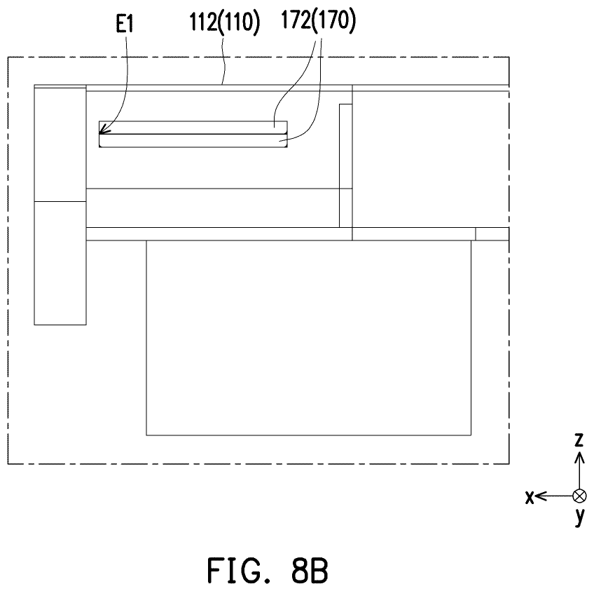

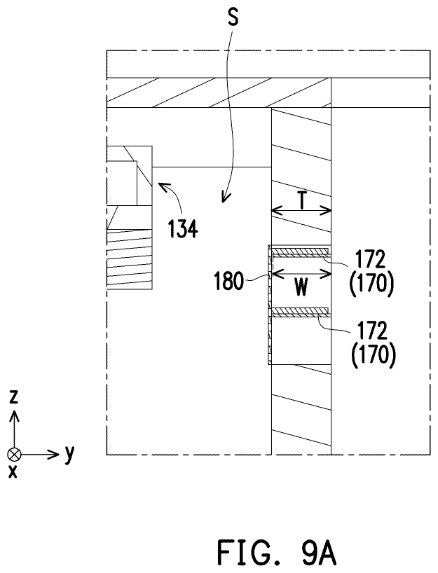

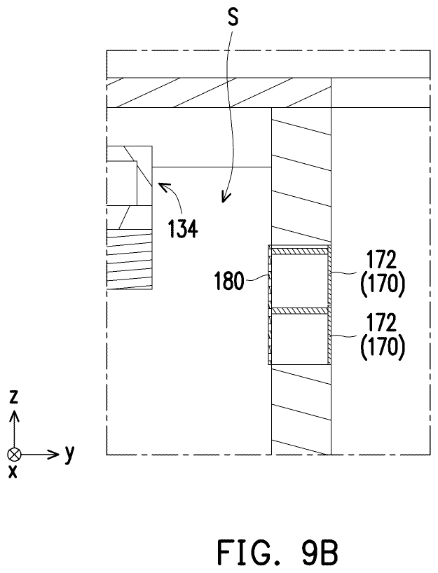

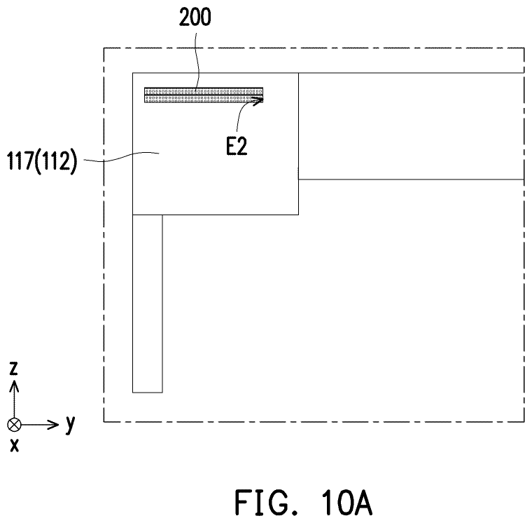

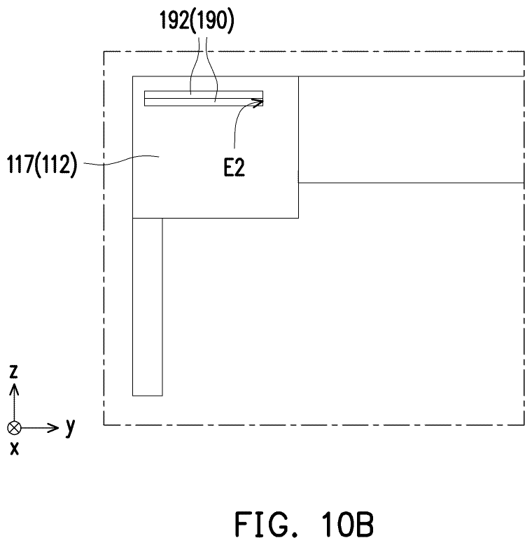

FIG. 1 is a schematic three-dimensional view of a wearable projection device according to an embodiment of the disclosure. FIG. 2 is a schematic partial front view of the wearable projection device of FIG. 1. FIG. 3 is a schematic view of an optical engine module of the wearable projection device in FIG. 1. FIG. 4 is a schematic cross-sectional view of the optical engine module in FIG. 3. FIG. 5 is a schematic cross-sectional view of an airflow generator of the wearable projection device in FIG. 1. FIG. 6A is a schematic rear perspective view of the wearable projection device in FIG. 1. FIG. 6B is a schematic rear perspective view of an airflow adjustment structure in FIG. 6A when it is closed. FIG. 7 is a schematic partial top perspective view of the wearable projection device in FIG. 1. FIG. 8A is a schematic partial front view of the wearable projection device in FIG. 6A. FIG. 8B is a schematic partial front view of the airflow adjustment structure in FIG. 8A when it is closed. FIG. 9A is a schematic cross-sectional partial side view of the wearable projection device in FIG. 1. FIG. 9B is a schematic cross-sectional partial side view of the airflow adjustment structure of FIG. 9A when it is closed. FIG. 10A is a schematic partial side view of the wearable projection device in FIG. 1 when the airflow adjustment structure positioned at the air outlet is opened. FIG. 10B is a schematic partial side view of the airflow adjustment structure of FIG. 10A when it is closed. For convenience of explanation, FIG. 1 is presented in partial perspective.

First, please refer to FIG. 1, FIG. 2, FIG. 5, and FIG. 6A simultaneously. In this embodiment, a wearable projection device 100 includes a body 110, an optical engine module 120, a heat-dissipation component 130, and a control module 140. The body 110 has an air inlet E1 and a containing space S connected to the air inlet E1. The optical engine module 120 is disposed in the containing space S of the body 110. The heat-dissipation component 130 is disposed in the containing space S of the body 110 to dissipate heat from the optical engine module 120. The heat-dissipation component 130 includes a vapor chamber 132 and an airflow generator 134. The vapor chamber 132 is connected to the optical engine module 120, and the airflow generator 134 is positioned on the vapor chamber 132, in which the airflow generator 134 includes a piezoelectric thin film 135. The control module 140 is disposed on the body 110 and is electrically connected to the optical engine module 120 and the airflow generator 134. The control module 140 is configured to drive the piezoelectric thin film 135 to vibrate, so that a cooling airflow F from outside enters the containing space S of the body 110 through the air inlet E1, so as to cool the vapor chamber 132.

In detail, please again refer to FIG. 1 and FIG. 6A simultaneously. In this embodiment, the body 110 further has an air outlet E2 connected to the containing space S. The body 110 includes a display part 112 and a support part 114 connected to each other, in which the containing space S is positioned in the display part 112. The display part 112 of the body 110 includes a first side wall 113 and a second side wall 115 opposite to each other and a connection wall 117 connecting the first side wall 113 and the second side wall 115. The air inlet E1 is disposed on the first side wall 113, and the air outlet E2 is disposed on the connection wall 117. The first side wall 113 of the display part 112 faces the user of the wearable projection device 100. It should be noted that, in this embodiment, the number of the air inlets E1 is schematically shown as two, and the number of the air outlets E2 is also two, respectively in the connection wall 117 on the left and right sides, but not limited thereto. It should be further explained that, the optical engine module 120, the heat-dissipation component 130, and the control module 140 according to this embodiment are only drawn on one side of the display part 112. However, in actual applications, the optical engine module 120, the heat-dissipation component 130, and the control module 140 may be disposed on both the left and right sides of the display part 112. Therefore, the optical engine module 120, the heat-dissipation component 130, and the control module 140 disposed on the other side of the display part 112 are not repeated here.

Furthermore, please refer to FIG. 3 and FIG. 4 simultaneously. In this embodiment, the optical engine module 120 is, for example, a projection device, in which the optical engine module 120 includes a light source device 122, an imaging module 124, and a lens module 126. The light source device 122 of the optical engine module 120 includes a light emitting element 123, and the light emitting element 123 is suitable for emitting an illumination light beam L1, in which the light emitting element 123 may be light emitting diodes (LED) or laser diodes (LD). However, the disclosure does not limit the type or form of the light source device 122, whose detailed structure and implementation manner may be sufficiently obtained from the teachings, suggestions, and implementation descriptions from common knowledge in the technical field, and are not repeated here.

Furthermore, the imaging module 124 of the optical engine module 120 is disposed on the transmission path of the illumination light beam L1, and is configured to convert the illumination light beam L1 to generate an image light beam L2. The imaging module 124 includes a lens element 125 and an imaging device, in which the lens element 125 is configured to transmit the illumination light beam L1, and the imaging device, such as a light valve, is configured to convert the illumination light beam L1 into an image light beam L2. For example, the light valve may be a reflective optical modulator such as a liquid crystal on silicon panel or a digital micro-mirror device. Alternatively, the light valve may be a transmissive optical modulator such as a transparent liquid crystal panel, an electro-optical modulator, a magneto-optic modulator, or an acousto-optic modulator. The disclosure does not limit the form and type of the light valve. Regarding the method of the light valve converting the illumination light beam L1 into the image light beam L2, whose detailed operation and implementation manner may be sufficiently obtained from the teachings, suggestions, and implementation descriptions from common knowledge in the technical field, and are not repeated here.

In addition, the lens module 126 of the optical engine module 120 is disposed on the transmission path of the image light beam L2 to project the image light beam L2 to a lens element 210 connected to the display part 112. The lens module 126 may include a combination of one or more optical lens elements having diopters, such as various combinations of non-flat lens elements including biconcave lens elements, biconvex lens elements, concave-convex lens elements, convex-concave lens elements, plano-convex lens elements, and plano-concave lens elements. In an embodiment, the lens module 126 may also include a flat optical lens element to project the image light beam L2 out of the body 110 in a reflective manner. The disclosure does not limit the form and type of the lens module 126.

Next, please refer to FIG. 2, FIG. 5, and FIG. 7 simultaneously. The vapor chamber 132 of the heat-dissipation component 130 according to this embodiment has a good thermal conductivity. In an embodiment, the interior of the vapor chamber 132 may include a capillary structure and a fluid, which can quickly and evenly distribute heat on the surface of the vapor chamber 132 through phase changes in the liquid. That is to say, the vapor chamber 132 is a structure having uneven thermal conductivity, in which the thermal conductivity coefficient of the vapor chamber 132 in the horizontal direction is different from the thermal conductivity coefficient in the vertical direction. Furthermore, the wearable projection device 100 according to this embodiment may further include a thermal conductive material 160 disposed between the vapor chamber 132 and the optical engine module 120. That is to say, the vapor chamber 132 may be connected to a heat source (such as the light emitting element 123 in FIG. 4) of the optical engine module 120 through the thermal conductive material 160. Therefore, when the piezoelectric thin film 135 of the airflow generator 134 vibrates, the cooling airflow F may be guided to enter the body 110 through the air inlet E1, and the vapor chamber 132 can be directly cooled by the cooling airflow F, so that the wearable projection device 100 according to this embodiment has a good heat dissipation efficiency. In an embodiment, the thermal conductive material 160 is, for example, a thermal interface material (TIM), but is not limited thereto.

Furthermore, the airflow generator 134 of the heat-dissipation component 130 according to this embodiment may be disposed on a side of the vapor chamber 132 away from the optical engine module 120 (as shown in FIG. 2). In another embodiment, the airflow generator 134 may also be disposed on a side of the vapor chamber 132 facing the optical engine module 120 (not shown), and the disclosure is not limited thereto. As shown in FIG. 5 and FIG. 6A, the airflow generator 134 according to this embodiment has an air inlet E3 and an air outlet E4, in which the cooling airflow F enters the containing space S through the air inlet E1 of the body 110, enters the airflow generator 134 through the air inlet E3 of the airflow generator 134, and flows along an airflow direction D generated by the airflow generator 134. At this time, the thermal conductivity coefficient of the vapor chamber 132 gradually increases along the airflow direction D, which means that the vapor chamber 132 has a high thermal conductivity coefficient at the air outlet E4 of the airflow generator 134.

In particular, as shown in FIG. 5, in this embodiment, the airflow generator 134 further includes a heat sink 137, in which the heat sink 137 includes a casing 138 and a metal plate 139, and the piezoelectric thin film 135 is connected to the casing 138 of the heat sink 137. The metal plate 139 has a good thermal conductivity and can distribute heat evenly, and the metal plate 139 can be cooled by the cooling airflow F introduced through the vibration of the piezoelectric thin film 135. That is to say, when the piezoelectric thin film 135 vibrates, the introduced cooling airflow F can impingement cool the metal plate 139 of the heat sink 137, and then the vapor chamber 132 is cooled through the metal plate 139 of the heat sink 137, which can improve the heat dissipation efficiency.

Please again refer to FIG. 1 and FIG. 2 simultaneously. The wearable projection device 100 according to this embodiment further includes a buffer member 150 disposed between the vapor chamber 132 and the airflow generator 134. The airflow generator 134 connects the vapor chamber 132 through the buffer member 150, which means that the airflow generator 134 does not directly contact the vapor chamber 132. It should be further noted that, the metal plate 139 of the airflow generator 134 may be attached to the buffer member 150. The buffer member 150 may be regarded as a kind of damper, which is elastic and can absorb vibration, thereby preventing the vibration from being transmitted to the optical engine module 120 and affecting the operation of the optical engine module 120. In an embodiment, the buffer member 150 is, for example, a thermal interface material (TIM), which can simultaneously absorb vibration and conduct heat.

Further, please refer to FIG. 2, FIG. 5, and FIG. 6A simultaneously. When the piezoelectric thin film 135 of the airflow generator 134 vibrates, the introduced cooling airflow F may enter the body 110 through the air inlet E1 along a negative Y-axis direction. At this time, a part of the cooling airflow F enters the airflow generator 134 along a negative Z-axis direction, so as to impingement cool the metal plate 139 through the vibration of the piezoelectric thin film 135. Furthermore, since the metal plate 139 and the vapor chamber 132 are connected through the buffer member 150, heat dissipation is also performed on the vapor chamber 132, and then the air is discharged to the air outlet E2 along an X-axis direction. Another part of the cooling airflow F that does not enter the airflow generator 134 directly flows to the vapor chamber 132, which can also achieve the heat dissipation effect on the vapor chamber 132. In addition, the cooling airflow F that directly flows to the vapor chamber 132 is also discharged to the air outlet E2 along an X-axis direction.

Please refer to FIG. 1 and FIG. 2 simultaneously. The control module 140 according to this embodiment is disposed in the containing space S, in which the control module 140 includes electronic elements, which may include, for example, a microprocessor or an image processor, but not limited thereto. In an embodiment, the thermal conductive material 160 is disposed between the vapor chamber 132 and the control module 140, in which the vapor chamber 132 connects the heat source of the control module 140 through the thermal conductive material 160. Here, the orthographic projection of the control module 140 on the vapor chamber 132 does not overlap the orthographic projection of the optical engine module 120 on the vapor chamber 132. It should be further noted that, the control module 140 may not only be disposed in the containing space S, but may also be disposed outside the body 110. For example, the control module 140 may be disposed on a side of the connection wall 117 away from the containing space S, but not limited thereto.

In this embodiment, please refer to FIG. 6A and FIG. 6B simultaneously. The wearable projection device 100 further includes an airflow adjustment structure 170 disposed on the body 110 and positioned at the air inlet E1. The airflow adjustment structure 170 includes a louver structure, where the louver structure is a structure in which a plurality of elongated plates may be arranged in parallel and aligned at certain intervals. Here, the louver structure is, for example, a plurality of louver blades 172, in which the plurality of louver blades 172 are arranged parallel to each other and without interference. Here, the number of the louver blades 172 is two as an example, but not limited thereto. In an embodiment, the louver structure may also be louver blinds. Next, please refer to FIG. 8A, FIG. 8B, FIG. 9A, and FIG. 9B simultaneously. FIG. 8A and FIG. 9A show the state in which the piezoelectric thin film 135 vibrates and guides the cooling airflow F to enter the body 110. FIG. 8B and FIG. 9B show the state in which the piezoelectric thin film 135 stops vibrating and does not guide the cooling airflow F to enter the body 110. In order to prevent the dust from entering the body 110 along with the cooling airflow F and thereby affecting the components in the body 110, the wearable projection device 100 according to this embodiment further includes a dust filter 180 disposed on the body 110 and covering the air inlet E1, in which the dust filter 180 is positioned between the airflow generator 134 and the airflow adjustment structure 170. As shown in FIG. 9A, a width W of each louver blade 172 may be less than or equal to a wall thickness T of the body 110. That is to say, when the airflow adjustment structure 170 is opened, the louver blades 172 may be hidden in the body 110 and do not occupy the interior space of the system, so as to achieve the purpose of lightweight.

Furthermore, as shown in FIG. 2, FIG. 6A, FIG. 8A, and FIG. 9A, when the control module 140 drives the airflow generator 134, the airflow adjustment structure 170 is configured to guide the cooling airflow F to enter the containing space S from the air inlet E1. That is to say, when the airflow generator 134 is in operation, each louver blade 172 may open in a single direction, so that the cooling airflow F may enter the containing space S from a space (not shown) between any two adjacent louver blades 172 and then flow through the dust filter 180, so as to cool the vapor chamber 132. Next, as shown in FIG. 2, FIG. 8B, and FIG. 9B, when the airflow generator 134 is not in operation, the plurality of louver blades 172 are closed to cover the air inlet E1, that is, the airflow adjustment structure 170 is closed to cover the dust filter 180, which can achieve the dust-proof effect.

Please refer to FIG. 10A and FIG. 10B. FIG. 10A shows the state in which the cooling airflow F is discharged from the containing space S from the air outlet E2. FIG. 10B shows the state in which the piezoelectric thin film 135 stops vibrating and does not guide the cooling airflow F to enter the body 110. The wearable projection device further includes an airflow adjustment structure 190 disposed on the body 110 and positioned at the air outlet E2, in which the airflow adjustment structure 190 may include a plurality of louver blades 192. When the control module 140 drives the airflow generator 134, the airflow adjustment structure 190 is configured to guide the cooling airflow F to discharge from the containing space S through the air outlet E2. In addition, the wearable projection device may also include a dust filter 200 disposed on the body 110 and covering the air outlet E2, in which the dust filter 200 is positioned between the airflow generator 134 and the airflow adjustment structure 190. When the airflow generator 134 is not in operation, the airflow adjustment structure 190 is closed to cover the dust filter 200, which can achieve the dust-proof effect. Regarding the structures of the airflow adjustment structure 190 and the dust filter 200 mentioned here, reference may be made to the structures and configurations of the airflow adjustment structure 170 and the dust filter 180 mentioned above, and are not repeated here.

In short, when the control module 140 drives the piezoelectric thin film 135 to vibrate, the cooling airflow F from outside may enter the containing space S of the body 110 through the air inlet E1, which can impingement cool the metal plate 139 of the heat sink 137, and then the vapor chamber 132 is cooled through the metal plate 139 of the heat sink 137. In this way, the fluid usage efficiency can be improved, and the noise can be expected to be reduced under the same power consumption. Furthermore, this embodiment improves the dust-proof design through the disposition of the airflow adjustment structure 170. In addition, the louver blades 172 of the airflow adjustment structure 170 can be hidden in the body 110, so as to achieve the lightweight design of the wearable projection device 100.

In summary, the embodiments of the disclosure have at least one of the following advantages or effects. In the design of the wearable projection device according to the disclosure, the heat-dissipation component includes the vapor chamber and the airflow generator including the piezoelectric thin film, in which the vapor chamber is connected to the optical engine module, and the airflow generator is positioned on the vapor chamber. When the control module drives the piezoelectric thin film to vibrate, the cooling airflow from outside may enter the containing space of the body through the air inlet, so as to cool the vapor chamber. That is to say, so as to impingement cool the vapor chamber after passing through the piezoelectric thin film. In this way, the fluid usage efficiency is improved, and the noise can be expected to be reduced under the same power consumption. In short, the wearable projection device according to the disclosure can have a good heat dissipation effect and display quality.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A wearable projection device, comprising:
a body having an air inlet, wherein the body has a containing space connected to the air inlet;
an optical engine module disposed in the containing space of the body;
a heat-dissipation component disposed in the containing space of the body and configured to dissipate heat from the optical engine module, wherein the heat-dissipation component comprises a vapor chamber and an airflow generator; wherein
the vapor chamber is connected to the optical engine module;
the airflow generator is positioned on the vapor chamber, wherein the airflow generator comprises a piezoelectric thin film; and
a control module disposed on the body and electrically connected to the optical engine module and the airflow generator, wherein the control module is configured to drive the piezoelectric thin film to vibrate, so that a cooling airflow from outside enters the containing space of the body through the air inlet, so as to cool the vapor chamber.

2. The wearable projection device as claimed in claim 1, wherein the body further has an air outlet connected to the containing space, the body comprises a display part and a support part connected to each other, the containing space is positioned in the display part, the display part comprises a first side wall and a second side wall opposite to each other and a connection wall connecting the first side wall and the second side wall, the air inlet is disposed on the first side wall, the air outlet is disposed on the connection wall, and the first side wall of the display part faces a user of the wearable projection device.

3. The wearable projection device as claimed in claim 2, further comprising:
an airflow adjustment structure disposed on the body and positioned at the air outlet, wherein in response to the control module driving the airflow generator, the airflow adjustment structure is configured to guide the cooling airflow to discharge from the containing space through the air outlet.

4. The wearable projection device as claimed in claim 3, further comprising:
a dust filter disposed on the body and covering the air outlet, wherein the dust filter is positioned between the airflow generator and the airflow adjustment structure, in response to the airflow generator not being in operation, the airflow adjustment structure is closed to cover the dust filter.

5. The wearable projection device as claimed in claim 1, further comprising:
a buffer member disposed between the vapor chamber and the airflow generator, wherein the airflow generator connects the vapor chamber through the buffer member.

6. The wearable projection device as claimed in claim 5, wherein the buffer member comprises a thermal interface material.

7. The wearable projection device as claimed in claim 1, further comprising:
a thermal conductive material disposed between the vapor chamber and the optical engine module, wherein the control module is disposed in the containing space, and the thermal conductive material is disposed between the vapor chamber and the control module.

8. The wearable projection device as claimed in claim 7, wherein an orthographic projection of the control module on the vapor chamber does not overlap an orthographic projection of the optical engine module on the vapor chamber.

9. The wearable projection device as claimed in claim 1, wherein the airflow generator further comprises a heat sink, and the piezoelectric thin film is connected to the heat sink.

10. The wearable projection device as claimed in claim 1, further comprising:
an airflow adjustment structure disposed on the body and positioned at the air inlet, wherein in response to the control module driving the airflow generator, the airflow adjustment structure is configured to guide the cooling airflow to enter the containing space through the air inlet.

11. The wearable projection device as claimed in claim 10, further comprising:
a dust filter disposed on the body and covering the air inlet, wherein the dust filter is positioned between the airflow generator and the airflow adjustment structure, in response to the airflow generator not being in operation, the airflow adjustment structure is closed to cover the dust filter.

12. The wearable projection device as claimed in claim 10, wherein the airflow adjustment structure comprises a louver structure, the louver structure comprises a plurality of louver blades, the plurality of louver blades are arranged parallel to each other without interference, and a width of each of the plurality of louver blades is less than or equal to a wall thickness of the body.

13. The wearable projection device as claimed in claim 12, wherein in response to the airflow generator being in operation, each of the plurality of louver blades opens in a direction, so that the cooling airflow may enter the containing space through a space between any two adjacent louver blades of the plurality of louver blades, and in response to the airflow generator being not in operation, the plurality of louver blades of the louver structure are closed to cover the air inlet.

14. The wearable projection device as claimed in claim 1, wherein the optical engine module comprises:
a light source device suitable for emitting an illumination light beam;
an imaging module disposed on a transmission path of the illumination light beam and configured to convert the illumination light beam to generate an image light beam; and
a lens module disposed on a transmission path of the image light beam to project the image light beam out of the body.

15. The wearable projection device as claimed in claim 1, wherein the cooling airflow enters the containing space through the air inlet and flows along an airflow direction generated by the airflow generator, and a thermal conductivity coefficient of the vapor chamber gradually increases along the airflow direction.
